(19) United States
(12) Patent Application Publication
(10) Pub. No.: US 2012/0271698 A1
(43) Pub. Date: Oct. 25, 2012

(54) Single Order Method For Independent Sales Representative As Used In The Party Plan Direct Marketing Method Of Selling Products

(76) Inventor: Kimberly Inskeep, Palos Verdes Peninsula, CA (US)

(21) Appl. No.: 13/535,172

(22) Filed: Jun. 27, 2012

Related U.S. Application Data
(63) Continuation of application No. 13/180,368, filed on Jul. 11, 2011.
Application No. 13/180,368 is a continuation of application No. 11/057,540, filed on Feb. 14, 2005, now abandoned.
(60) Provisional application No. 60/544,436, filed on Feb. 13, 2004.

(51) Int. Cl. G06Q 30/06; G06Q 30/02

(52) U.S. Cl. 705/14.23; 705/26.81; 705/26.8

(57) ABSTRACT

A business method and system for executing the method that involves gathering merchandise orders at a show in the home of a hostess. The method compiles the merchandise orders while maintaining a relationship between each individual order and information pertaining to the guest making the order. The guest information maintains an association with the order throughout the method such that each order made at the show may be individually packaged and labeled, obviating the need for the hostess to sort the ordered items upon receiving them from a warehouse.

### CROSS REFERENCE TO RELATED APPLICATIONS

The present application is a continuation of U.S. patent application Ser. No. 13/180,368 filed Jul. 11, 2011 entitled Single Order Method For Independent Sales Representative As Used In The Party Plan Direct Marketing Method Of Selling Products [as amended], which is a continuation of U.S. patent application Ser. No. 11/057,540 filed Feb. 14, 2005 entitled Single Order Method For Independent Sales Representative As Used In The Party Plan Direct Marketing Method Of Selling Products [as amended], which is related to and claims priority from U.S. provisional application Ser. No. 60/544,436 filed on Feb. 13, 2004 entitled Single Order Method For Independent Sales Representative, all of which are incorporated herein by reference in their entireties.

### BACKGROUND OF THE INVENTION

The traditional retail market is one of the oldest, and yet still most prevalent, business models for selling goods. One popular alternative to traditional retail shopping is the “party plan” direct marketing method of selling products. The party plan was made well known by the Tupperware® Corporation. Rather than buying the Tupperware® products from a retail store, groups of potential customers, usually women, get invited to a “show” or “party” (hereinafter a “show”) at a host's home. The show is led by an independent sales consultant who showcases the products, enticing the partygoers into ordering the wares.

At the conclusion of the party, the consultant takes the orders and submits them to the company to be filled. Typically, the hostess maintains copies of all of the items ordered by the various customers. The consultant simply enters a “grand total” of the items ordered, including the hostess name and address, and sends the order to a factory or warehouse where the order is filled. The items are packed into a box and shipped to the hostess's house to save on shipping. Upon receiving the shipment, it is the hostess's responsibility to refer to the order forms and compile the individual orders from the shipment received. This step can take hours. The hostess will then notify each of the guests that ordered items that their newly purchased items may be picked up at the hostess's house.

After the items are received by the guests, if there are any returns to be made, the responsibility typically falls on the hostess to receive the item back from the guest and send it to the manufacturer, receive the exchange or credit, and pass the exchange or credit back to the guest. In consideration for hosting the party, the hostess is usually given a gift or a discount on one or more items of her order, based on the amount of merchandise sold during her show.

The party plan marketing model has expanded significantly to include products other than kitchen wares. Popular direct marketing companies have been established for baskets, candles, cosmetics and clothing. Clothing orders can be particularly burdensome on a hostess using the present model for several reasons.

First, in a given line of clothing there are usually a few items that are more popular so many of the guests will order this item. Often, the item comes in multiple sizes and colors. Thus, when the shipment arrives to the hostess's house, the task of compiling the various orders becomes even more difficult because the hostess has to ensure that each order receives not only the correct items, but the correct sizes and colors of each item.

Second, because each of the items requires sorting by the hostess, this puts the hostess in the undesirable position where she must decide whether she has the time and energy to organize and individually inspect each of the items to avoid having unsatisfied customers. Performing this task for numerous customers may lead to a decision not to host subsequent shows.

Third, clothing items tend to be returned more often than other types of purchases. Getting an item home and trying it on in a familiar environment, or even just in a different mood, can cause a buyer to regret a purchase. As described above, returns must be made by the hostess because only the hostess is in the manufacturer's database.

Fourth, many direct sales clothing companies require the sales consultant to act as the hostess due to the logistics of moving the large quantity of clothes typically shown at a show. Thus, typical direct clothing companies require their consultants to sign up for a block of time, usually two weeks, during which they take possession of the sample wardrobe. This sample wardrobe is of considerable size. The consultant receives the wardrobe and turns her house into a retail environment where she showcases the clothes constantly for two weeks. Rather than having parties or shows, she invites as many people as possible to stop by anytime during her possession of the wardrobe to try on and hopefully order clothes. After her block of time has elapsed, she packs up the sample wardrobe and sends it on to another consultant. The time during which she is in possession of the wardrobe is a time of considerable inconvenience to her family.

The advent of the internet has given rise to other forms of direct marketing including online auctions, flea markets, and direct access to manufacturers. Web-based shopping has not obviated the “party plan,” however. Many shoppers find there is no substitute for physically handling and examining an item while deciding whether to make a purchase. Women's clothing is an example of a product type where this is especially true. Most women will agree that seeing an outfit on a glamorous model in a picture on a website provides little comfort that they will like the way the outfit looks on them. A “party plan” marketing method has this major advantage over internet shopping as a business model for women's fashion. The internet, however, provides undeniable flexibility and management tools. Orders can be taken, reviewed, and tracked instantly. Nonetheless, few party-oriented direct sales methods utilize the versatility and convenience availed by the internet.

There is a need for a web-based business model that incorporates the advantages provided by the internet with the “party plan” direct marketing model. More specifically, there is a need for a web-based program that assists the hostess of a party in taking and placing orders. There is a further need for such a program that tracks information related to each customer and allows the customers to make returns and exchanges directly with the manufacturer.

### BRIEF SUMMARY OF THE INVENTION

The present invention fills the aforementioned needs by providing a web-based system for assisting an entrepreneur, such as an independent sales representative, in tracking and managing sales and benefits generated in a sales party environment. The present invention also assists the hostess of a party as it makes individually wrapped packages possible.

One aspect of the present invention provides a method for making sales transactions initiated at a show in the home of a hostess. The method includes gathering information about the hostess, including her address, and customer data such as name, address, and payment information. After the show, the information is entered into a database and sent to a warehouse via the internet. Because the customer data is also received, the warehouse is able to place the individual orders for each guest together in a package, and then ship a box or boxes containing the various packages to the hostess. The packages arrive neat and presentable. The hostess needs do no more than notify her guests that their packages have arrived so that the guests may pick up the packages from the hostess.

Another aspect of the invention provides a system for executing the aforementioned method. The system includes a consultant computer in data communication with a database. A second computer at warehouse holding the goods for sale is also in data communication with the database. The second computer is configured to perform the steps of receiving hostess information, guest information and customer orders. Next the second computer generates a show code based on the hostess information. The second computer then calculates billing totals, factoring in any discounts that may apply, and generates order forms for use at the warehouse in assembling the orders.

### BRIEF DESCRIPTION OF THE DRAWINGS

FIG. 1 is a schematic of the structure of the business model of the present invention;

FIG. 2 is a chart of the business method of the present invention;

FIGS. 3-4 are menu screens of the present invention;

FIG. 5 is a customer order form of the present invention;

FIGS. 5-12 are menu screens of the present invention.

### DETAILED DESCRIPTION OF THE INVENTION

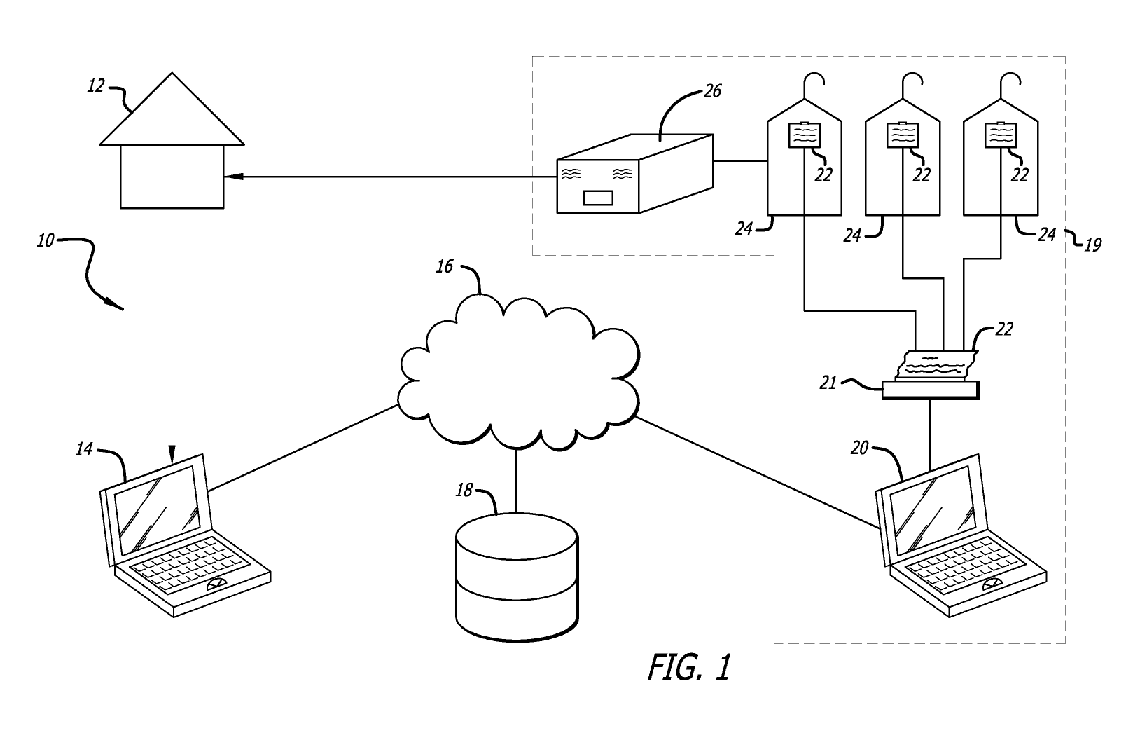

Referring now to the figures, and first to FIG. 1, there is shown a basic schematic diagram of the structure 10 of the business method of the present invention. The structure 10 includes a hostess home 12 where the show is to be held. The structure also includes a computer 14 having access to a network 16 in data communication with a database 18. The database 18 stores data on a computer readable medium and may or may not be located within a manufacturing site or warehouse 19. A second computer 20 is located at the warehouse 19 and is capable of generating orders based on the information stored in the database 18. Preferably, a printer or other form of interface 21 is in data flow communication with the second computer 20. The interface 21 is capable of producing order forms 22 containing the information generated by the computer 20. In the warehouse 19, the orders are taken and assembled into packages 24, which are then placed in a box 26 and shipped back to the hostess's home 12.

The computer 14 may be any computational device capable of receiving information and sending it to a remote location via the network 16. Typically, the computer 14 will be a personal computer or laptop owned by the consultant. However, the computer 14 is basically a communications device and could be embodied as a handheld digital device, cellular telephone, or any telecommunications device capable of data transfer. Alternatively, the computer 14 could be the combination of a standard telephone and a computer-automated answering service.

The network 16 is likely the internet for purposes of convenience. However, an intranet, satellite link, or any other form of data communications link would be acceptable.

The database 18 is connected to the network 16 and has the capability of storing information on a computer readable medium. The database 18 may or may not be located within the warehouse 19. For example, the database 18 may be memory on a server at any location.

The computer 20 is preferably contained within the warehouse 19 and is in data communication with the network 16. The computer 20 is capable of manipulating data stored in the database 18 and generating order forms 22 and sending them to the interface 21.

The interface 21 is any form of output device capable of converting the information received from the computer 20 into a format readable by a means for assembling the merchandise on a given order 22. This means is typically a human worker and thus, the interface 21 would be a printer that generates printed order forms 22. Alternatively, the orders 22 could by assembled via automated machinery. In this case, the interface 21 may generate bar codes. In yet another embodiment, the interface may be a network, wireless or otherwise, that allows the computer 20 to communicate directly with automated machinery. In this case, a printer would be necessary to generate labels for the packages 24 and mailing labels for the boxes 26.

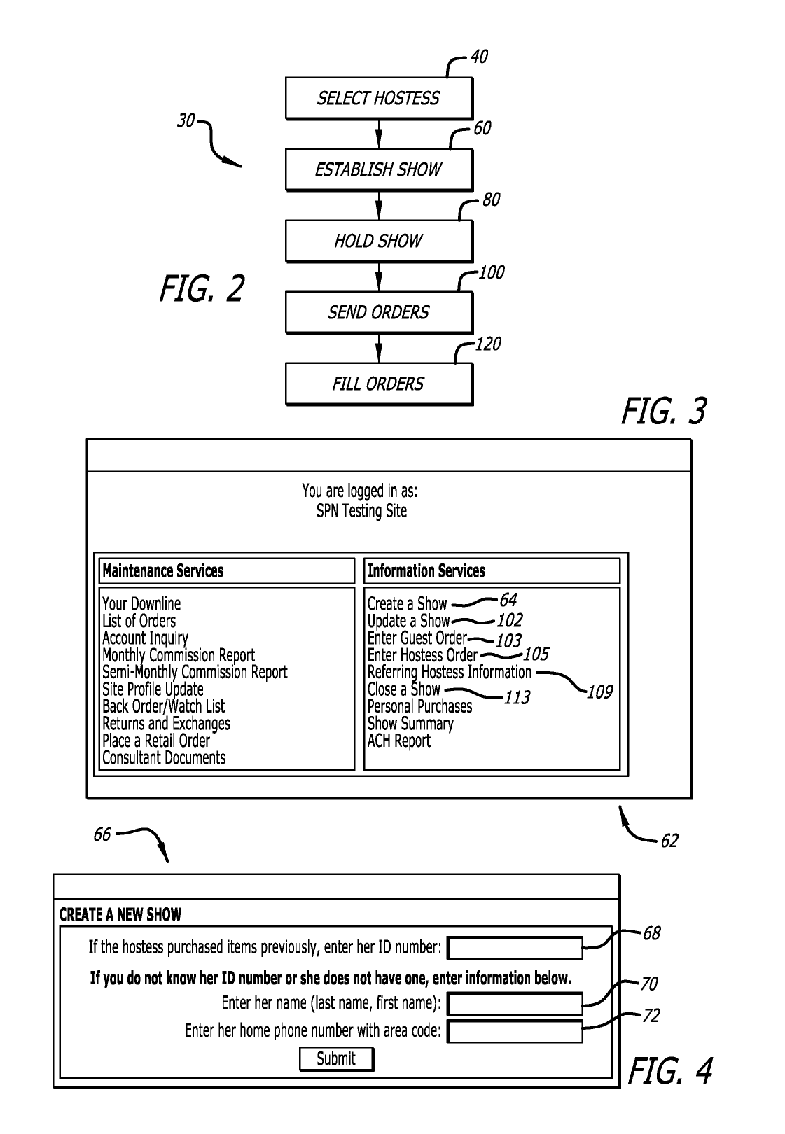

FIG. 2 outlines the general steps of the method 30 of the present invention. Each of these steps will be discussed in greater detail below and integrated with the aforementioned structure 10.

The method 30 begins with the selection of a hostess at 40. Hostess information is then entered into the database 18 and a show code is generated, thus establishing the show at 60. The show is then held at 80 where orders are taken for merchandise. The orders are sent to the warehouse 19 at 100 and are filled at 120. At 140, the merchandise is shipped back to the hostess's house where it is distributed to the guests who ordered the merchandise. Each of the steps will now be explained in greater detail.

Beginning with step 40, the hostess is chosen by the consultant. Quite often, a hostess will volunteer at a prior show to be the hostess of a future show. The hostess of the prior show will then be considered a “referring hostess” and will receive a discount if she attends the show at the hostess's house 12. The consultant and the hostess agree on a show date. Prior to the show date, the consultant may provide advice to the hostess in order to ensure a lucrative show. For example, the consultant may provide materials such as tip sheets, invitations, order guides, order forms, thank you cards, and the like.

Step 60 is completed by gathering information about the hostess and entering the information into the first computer 14 and sending it to the database 18 via the network 16. This information includes, at a minimum, the hostess's name. The show is then assigned a code. The show code will be used as a reference for the individual customer orders made at the show.

FIG. 3 shows a menu screen 62 the consultant will see upon logging in to the program via the network 16. Under the heading “Information Services” the option “Create a Show” 64 is selected. Doing so causes the menu screen 66 shown in FIG. 4 to appear. Here the consultant fills in a hostess ID number field 68 if the hostess has been established as a customer in the database 18 at a previous show. If not, the consultant enters the hostess's name in the hostess name field 70 and the hostess phone number in the phone number field 72. There may also be a field for hostess address. Alternatively, the hostess address will be entered from an order form filled in at the party.

At step 80, the show is held at the home of the hostess. The consultant brings a sample line of clothing to the hostess's home. Rather than leasing the sample line for a period of time, the consultant purchases the sample line from the company at or slightly below the cost to the company. In order to ensure their consultants are not simply becoming consultants to buy clothes at significantly reduced prices, the sample line includes a variety of sizes and is a set sample line package for all consultants. The consultants are not able to assemble a sample line of their own by ordering individual items at or below cost.

Furthermore, each consultant must meet several requirements. First, the consultant must purchase a new sample line each season (e.g. spring and fall). Second, each consultant must present their sample lines at a minimum number of shows per season (e.g. two shows per month). Third, each consultant must generate a minimum amount of gross sales per month (e.g. $10,000 per month during each season).

Understanding that, after a season is over, each consultant now owns a considerable number of clothing items in various sizes, each consultant is allowed to sell items from her sample line. This way, she is able to recoup some of the costs she has incurred.

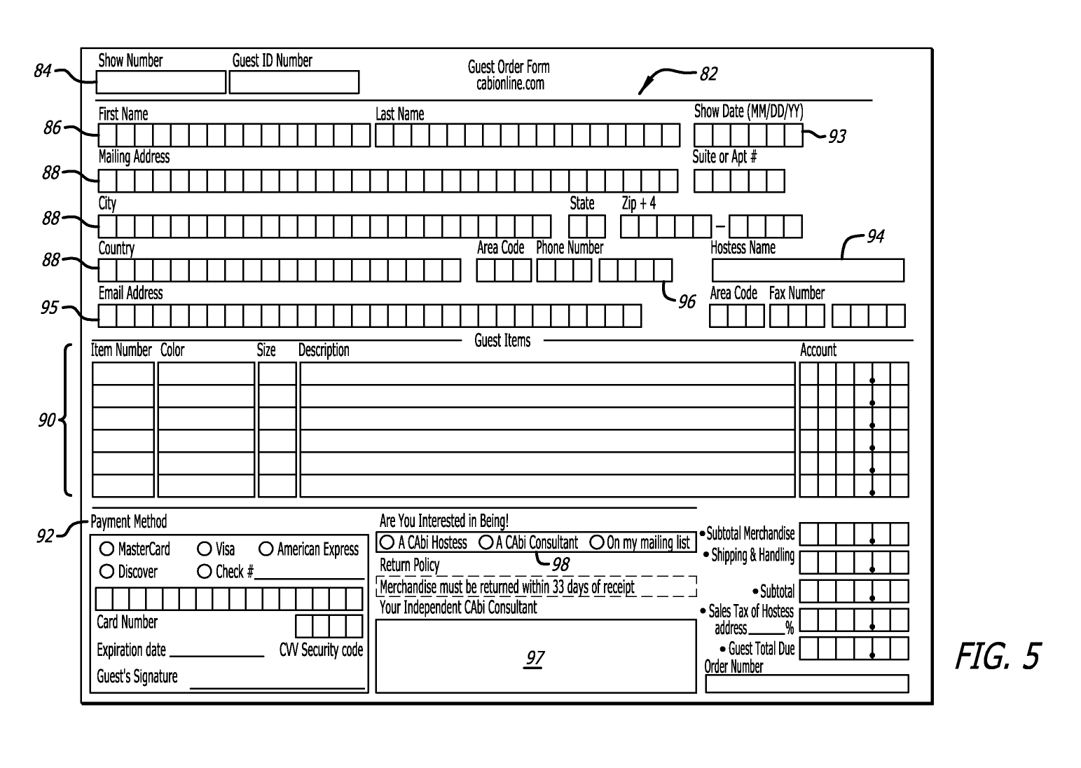

During the show, the consultant will introduce her sample line of merchandise and allow the guests to examine the same. Clothing items may be tried on by the guests. At the end of the show, order forms from the guests are received. FIG. 5 provides an example order form 82. These order forms include certain data fields such as the show code 84, the guest name 86, the guest address 88, the guest's order 90 of one or more merchandise items, and the payment account 92. Typically the payment account will consist of a credit card number and expiration date.

The order form 82 may also include data fields such as show date 93, hostess name 94, guest e-mail address 95, guest phone number 96, and consultant information 97. An interest field 98 may also be included giving the guest the option to express interest in hosting a future show or becoming a consultant.

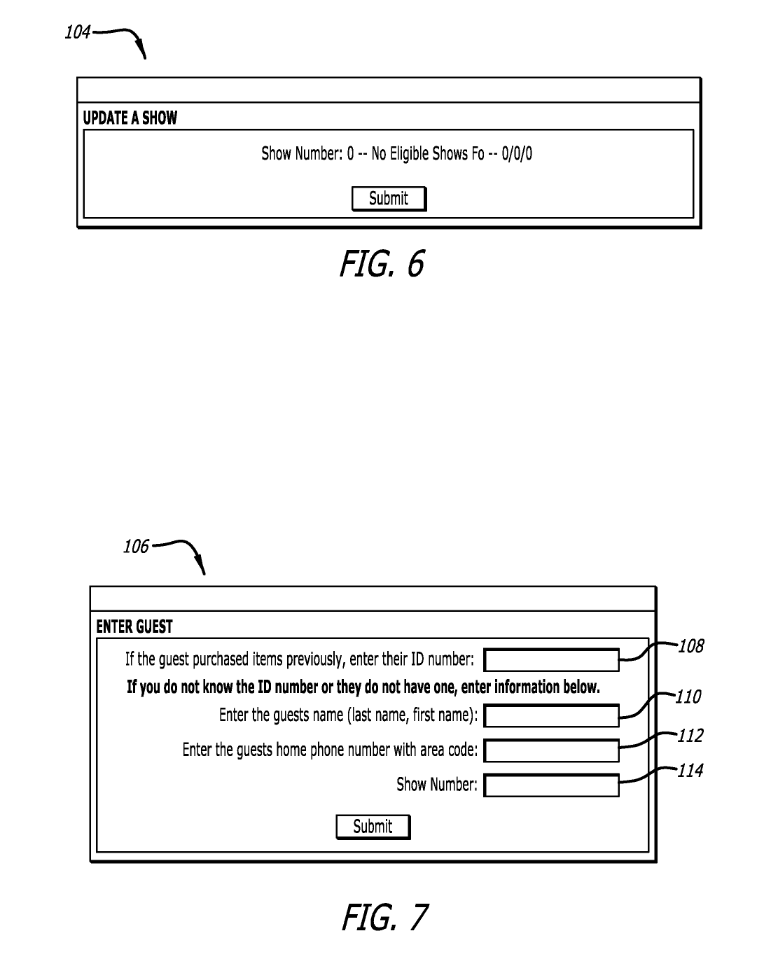

At step 100, the consultant gathers the order forms 82 from the show, leaving copies with the hostess, and enters the information therefrom into her computer 14. She does so by first selecting the “Update a Show” option 102 from the menu in FIG. 3. Doing so causes the menu 104 of FIG. 6 to appear. Here, she enters the show code established at 60. Once the show code is entered, the menu 106 shown in FIG. 7 appears. Here, historical facts are collected related to the show. Data pertaining to each individual guest attending the show is entered. Specifically, the guest ID number is entered in field 108 if the guest has an established ID number from a previous show. If not, the guest's name is entered into the name field 110, and her phone number is entered into the phone number field 112. The program should fill in the show number automatically into the show number field 114.

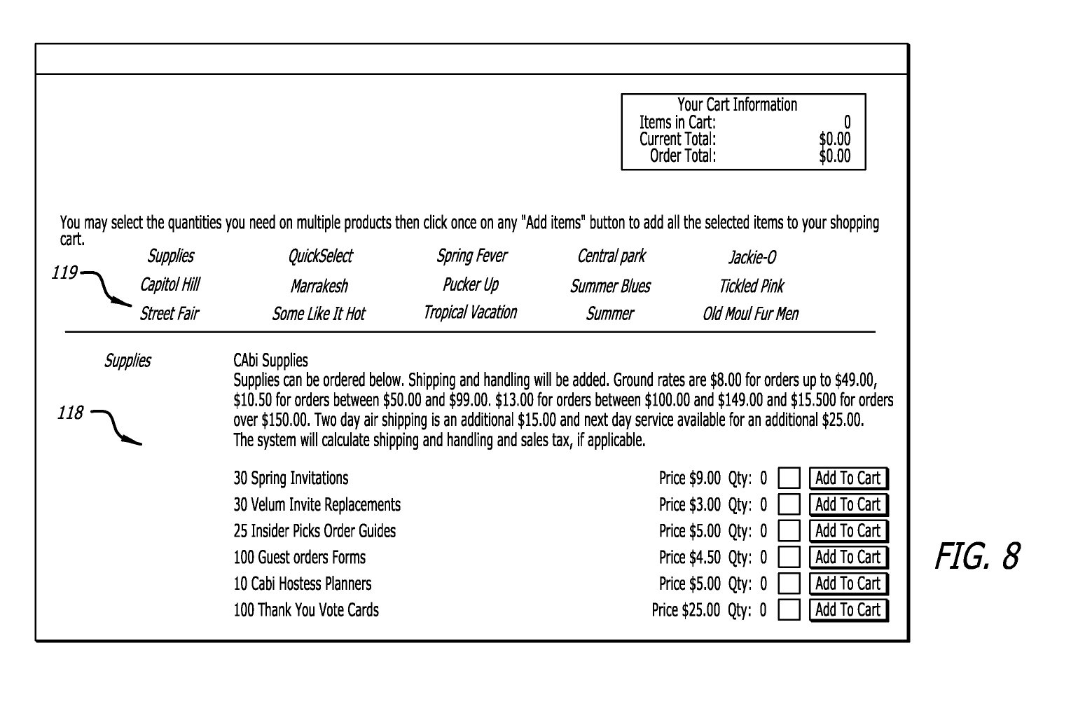

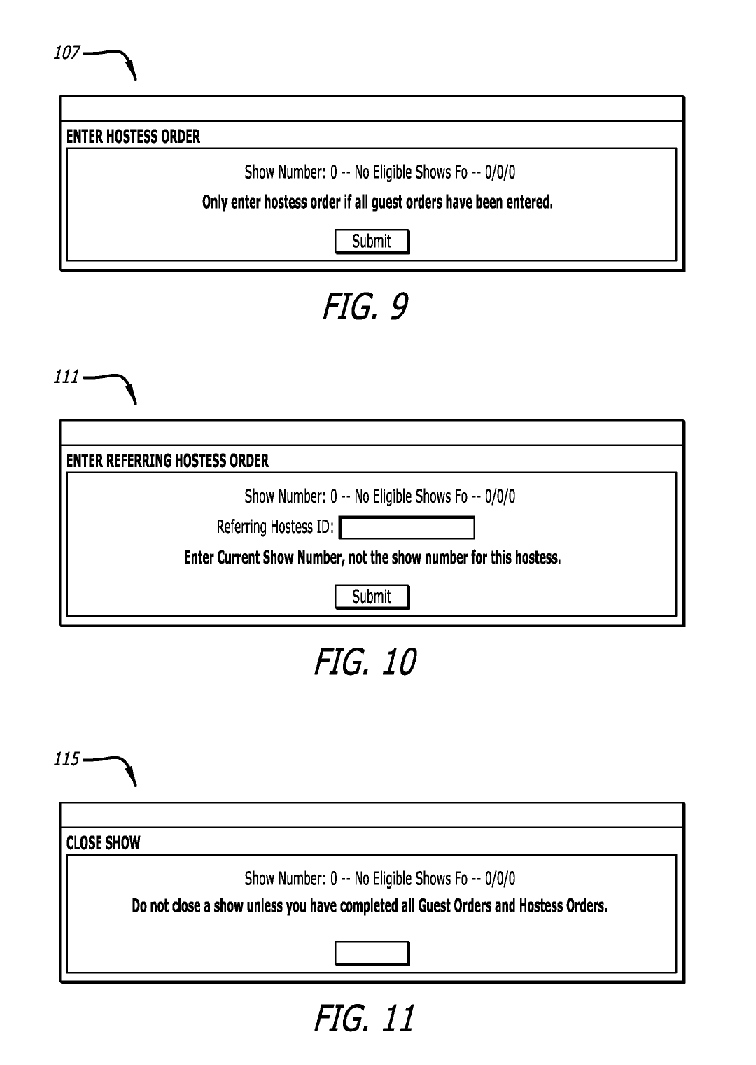

After the guest is entered into menu 106, “Enter Guest Order” 103 is selected from menu 62 (FIG. 3) and the order menu 116, shown in FIG. 8, will appear giving the entire line of products. The consultant carefully adds the correct quantities and sizes to the guest's cart from the guest's order form 82. The order menu 116 shows a submenu 118 listing all of the supplies a consultant might want to order and provide a future hostess. However, similar submenus 118 are made available from each of the various product lines shown in the product line submenu 119. This process is repeated for each guest, first entering the guest into the menu 106 and then the guest's order into the order menu 116. Once the guests are all entered, the hostess information is entered. Instead of selecting “Enter Guest Order” 103 from menu 62, “Enter Hostess Order” 105 is selected and menu 107 appears (FIG. 9). This menu reminds the consultant that all of the other guest orders should have been entered first. The hostess's order is entered just like the other guest orders. In the event that a referring hostess attended the show, her order is entered last so that a discount may be calculated based upon the total sales of the show. The consultant thus selects “Referring Hostess Information” 109 from the menu 62 and the menu screen 111 of FIG. 10 appears. The referring hostess necessarily has a customer ID so that is entered, identifying her as a referring hostess.

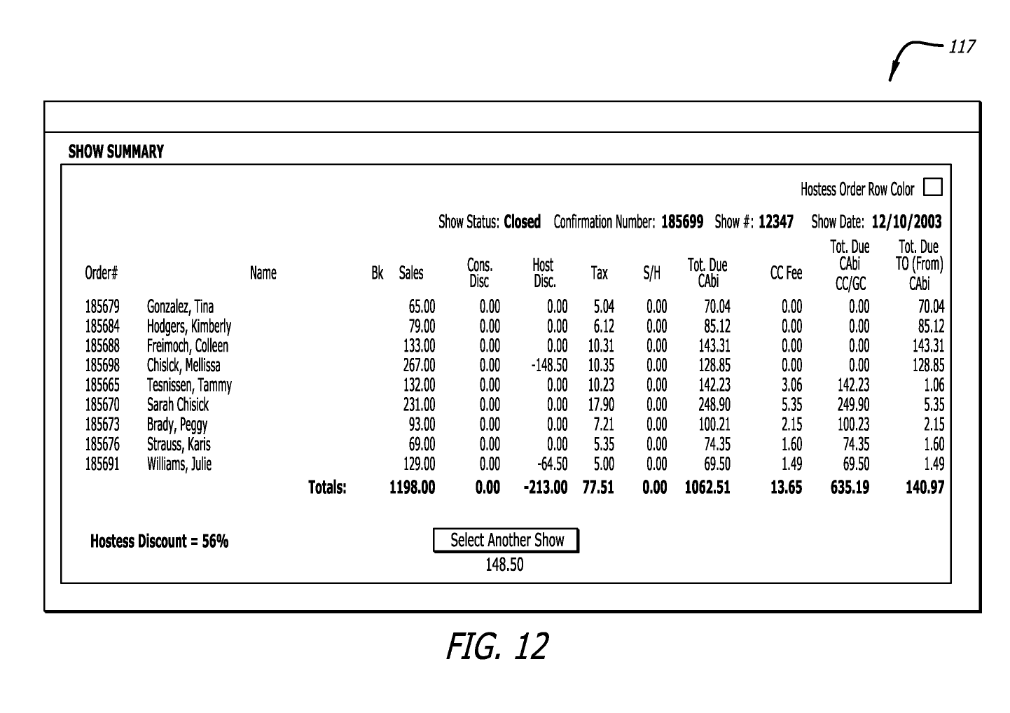

After the consultant has entered all of the information and orders from all of the guests, and she is confident the information entered is accurate, she closes the show. Closing the show entails selecting 113 from menu 62 causing the menu screen 115 (FIG. 11) to appear. Closing the show finalizes the orders and sends the information via the network 16 (FIG. 1) to the database 18. Upon closing the show, a summary screen 117 (FIG. 12) appears, showing all of the customers and their orders for that show.

At step 120 the process of filling the orders begins by accessing the database 18 using the second computer 20 and retrieving data from a closed show. The data is processed by the computer 20 and sent to the interface 21 for conversion into order forms 22. Preferably, each of the order forms 22 is retrieved by a worker who manually fills each order. Filling the order is accomplished by hand selecting each item on the order and individually wrapping the clothing items in a professional manner. The individual items for a given order are then bundled together and wrapped to form a package 24. Preferably, the order form 22 is taped to the package for identification purposes. Each of the packages 24 for that show are placed together in a box 26 and shipped to the hostess address. The hostess then notifies each of the guests that their packages 24 have arrived and are ready for pickup.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A method for making sales transactions initiated at a show in the home of a hostess comprising:
entering information relating to a show into a database on a computer readable medium, the information including:
hostess name;
assigning a code to the show;
receiving order forms from the hostess and guests at the show, the order forms having data including:
said show code;
customer name;
customer address;
customer order, the customer order including one or more merchandise items;
payment account;
storing the data on the order forms into the database;
associating the data from each of the order forms with the information related to the show based on the show code;
accessing the data from a remote location containing stored merchandise;
assembling and packaging the items of a given guest order to form a package;
labeling the package with at least the guest name;
placing all of the packages associated with the show code in a box;
shipping the box to the address of the hostess;
charging the payment account included on each order form an amount for the guest order.

2. The method of claim 1 wherein the step of entering information relating to a show into a database comprises entering an identifier for a referring hostess.

3. The method of claim 2 wherein charging the payment account included on each order form an amount for the customer order comprises discounting the amount if the order form contains the identifier for the referring hostess.

4. The method of claim 2 wherein entering an identifier for a referring hostess comprises entering a name of the referring hostess.

5. The method of claim 2 wherein entering an identifier for a referring hostess comprises entering an identification code for the referring hostess.

6. The method of claim 1 wherein entering information relating to a show into a database on a computer readable medium, further comprises entering the hostess's telephone number.

7. The method of claim 1 wherein charging the payment account included on each order form an amount for the guest order comprises identifying a guest order made by the hostess as a hostess order and applying a discount to the hostess order based on the total value of the items ordered for a given show code.

8. The method of claim 1 wherein charging the payment account included on each order form an amount of the guest order comprises identifying a guest order made by a referring hostess as a referring hostess order and applying a discount to the referring hostess order.

9. The method of claim 8 wherein applying a discount to the referring hostess order comprises identifying a most expensive item on the referring hostess order and applying a percentage discount to said most expensive item.

10. A system for effecting sales transactions initiated at a show in the home of a hostess comprising:
a first computer;
a second computer;
a database;
a network allowing data flow communication between the first computer, the second computer, and the database;
an interface in data flow communication with the second computer, the interface located in a warehouse containing merchandise;
wherein the second computer is configured to perform the following steps:
receiving the following information from the first computer and storing said information in the database:
hostess information;
guest information;
customer orders;
generating a show code based on the hostess information;
calculating billing totals;
generating order form data for each customer order and sending said order form data to the interface for communication to a means for assembling the orders, the order form data including the information of either the hostess or guest originating the customer order.

11. The system of claim 10 wherein the database comprises the internet.

12. The system of claim 10 wherein the database comprises an intranet.

13. The system of claim 10 wherein the hostess information the second computer is configured to receive comprises:
hostess name;
hostess address.

14. The system of claim 13 wherein the hostess information the second computer is configured to receive further comprises hostess telephone number.

15. The system of claim 10 wherein the guest information the second computer is configured to receive comprises:
guest name;
guest address.

16. The system of claim 10 wherein the second computer is further configured to generate customer identification codes for each guest and hostess.

17. The system of claim 10 wherein the second computer is further configured to apply hostess discounts to the billing totals based on the total customer orders.

18. The system of claim 10 wherein the interface comprises a printer.

19. The system of claim 10 wherein the interface comprises a data link to automated assembling machinery.

20. The system of claim 10 wherein the second computer is further configured to receive referring hostess information and to apply a referring hostess discount while calculating billing totals.
